(19) United States
(12) Patent Application Publication
(10) Pub. No.: US 2014/0297341 A1
(43) Pub. Date: Oct. 2, 2014

(54) SYSTEM AND METHOD FOR FORENSIC ANALYSIS AND INVESTIGATION OF DIGITAL DATA IN DIGITAL MEDIA DEVICE

(71) Applicant: SAMPARA SUNDARA SRIKANTH, VISAKHAPATNAM (IN)

(72) Inventor: SAMPARA SUNDARA SRIKANTH, VISAKHAPATNAM (IN)

(21) Appl. No.: 14/225,722

(22) Filed: Mar. 26, 2014

(30) Foreign Application Priority Data
Mar. 28, 2013 (IN) 349/CHE/2013

(51) Int. Cl. G06Q 10/06

(52) U.S. Cl. CPC G06Q 10/063
USPC 705/7.11

(57) ABSTRACT

The embodiments herein provide a method and system for analyzing and investigating digital data stored in digital device. The method comprises acquiring a disk image comprising digital data from a digital device of an exhibit, loading the disk image using a disk analysis tool, analyzing the disk image through a graphical user interface or browser interface for searching for the evidence by a visualization and interactive analysis module, managing the investigation process among an investigation team by an investigation management module, handling the workflow collaboration within the investigation team by a workflow and collaboration module, processing one or more text base documents by a text mining module, and representing the entire disk image visually to the investigator for easy, interactive and intuitive analysis of the exhibit. The text mining module comprises one or more advanced text mining algorithms for processing text based documents to extract critical information.

### CROSS-REFERENCE TO RELATED APPLICATIONS

This application claims the benefit and the priority of an Indian Patent Application with serial number 349/CHE/2013 filed on Jan. 27, 2013 and post dated to Mar. 28, 2013 with a title, “METHOD FOR ANALYZING AND INVESTIGATING DIGITAL DATA STORED IN DIGITAL DEVICES”. The contents of the abovementioned application are incorporated in entirety herein at least by reference.

### BACKGROUND

1. Technical Field

The embodiments herein generally relate to a field of digital forensics and particularly relates to a method and system for a forensic analysis of digital data. The embodiments herein more particularly relates to a method and system for providing a visual, intuitive and interactive aid or tool for performing forensic analysis and investigation on a disk image of a digital media device.

2. Description of the Related Art

The field of digital forensics is gaining prominence in fraud investigations, especially with the proliferation of electronic devices. Although most often associated with the investigation of a wide variety of cyber-crimes, the digital forensics may also be used in civil proceedings. A data recovery in civil proceedings involves additional guidelines and practices that are designed to create a legal audit trail. It is now a necessary and essential process in any investigation, to acquire a hard-disk ‘image’ and mobile phone image of a suspect to aid in investigation. In almost all investigations, these digital images play a very important role or a crucial vital role in providing the leading clues and evidence.

In the investigation of financial and corporate frauds, this disk imaging and subsequent analysis of the images often leads to significant findings, and hence a lot of time and resources are spent in this part of investigation. The goal of the disk image analysis for forensic evidence is to help the Investigation Officers (IOs) or investigators to easily access and examine a digital media in a forensically sound manner with the aim of identifying, preserving, recovering, analyzing and presenting the facts and opinions about the information. With the increasing capacities of hard disks and amount of information that is generated in our day-to-day lives and day-to-day business transactions, analyzing a hard-disk image or a mobile image for a clue or evidence is very difficult and cumbersome. This is the most time consuming and resource intensive part of any fraud investigation.

In addition to above difficulties, some of the other challenges faced in most investigations are a lack of adequate awareness among the investigators about technology. Also, the engineers lack the mindset of the investigators and hence cannot get the context of investigation in analyzing the disk. There is a huge risk in completely missing a key piece of information. The lack of legal knowledge among technology workers further increases the risk i.e. legality of what files can be viewed at time of imaging and provisions available as per cyber law of land. When submitting the documents or insights to the investigators with proper tagging needs to be according to the law of the land. Since the engineers carry out the content analysis and keyword searches, they do not net enough time to conduct a thorough digital forensic tests and other advanced analysis on the disk image thereby missing an opportunity to add value to the investigation.

Hence, there is a need for a method and system for the investigators to interactively analyze and investigate digital data stored in the digital devices of suspect. Also, there is a need to provide a visual, intuitive module to the investigators for easy and quick retrieval of required evidence from the disk image. Further, there is a need for a method and system to enable the investigators to conduct an investigation related task effectively with less dependence on the technical members. Still further, there is a need for a method and system for seamlessly collaborating the investigators working on a case for information sharing and analysis.

The above mentioned shortcomings, disadvantages and problems are addressed herein and which will be understood by reading and studying the following specification.

### OBJECTS OF THE EMBODIMENTS

The primary object of the embodiments herein is to provide a method and system for investigators to analyze and investigate digital data stored in a disk image of a digital device.

Another object of the embodiments herein is to provide a visual, intuitive and interactive interface based methods for efficiently performing investigation of a disk image.

Another object of the embodiments herein is to provide a method and system for enabling an investigator to perform investigation of a disk image with less dependency on other members.

Yet another object of the embodiments herein is to provide an advanced text mining algorithm based method for processing and analyzing a digital document and visually representing the result.

Yet another object of the embodiments herein is to provide a method utilizing advanced search and indexing techniques to perform rapid and complete thorough searches in the disk image.

These and other objects and advantages of the embodiments herein will become readily apparent from the following detailed description taken in conjunction with the accompanying drawings.

### SUMMARY

The embodiments herein provide a computer implemented method executed on a computing device for a forensic analysis and investigation of a digital data stored in digital device. The method comprises the steps of acquiring a disk image comprising a digital data from a digital device of an exhibit, loading the disk image using a disk analysis tool, analyzing the disk image through a graphical user interface or a browser interface for searching an evidence by a visualization and interactive analysis module, managing an investigation process among an investigation team by an investigation management module, handling a workflow collaboration within the investigation team by a workflow and collaboration module, processing one or more text based documents by a text mining module, and wherein the text mining module comprises one or more advanced text mining algorithms for processing the text based documents to extract a required information, and wherein the text miming algorithm is applied on a plurality of relevant documents and E-mail conversations to and from the exhibit and representing the entire disk image visually to the investigator fur an interactive and intuitive analysis of the exhibit.

According to an embodiment herein, wherein the disk image is a copy of a hard disk of a digital multimedia device of a user, and wherein the user is a suspect and a subject under investigation, and wherein the multimedia device includes mobile phone, laptop, tablet, and personal computer, and wherein the disk image is a forensic image of the device under investigation.

According to an embodiment herein, the visualization and interactive analysis module further comprises a phrase net module for providing a resolution of a keyword used in a plurality of contexts, and wherein the phrase net module assists the investigator in differentiating a usage of a keyword in a plurality of ways, an interactive keyword analysis module for providing a list of suitable keywords for search in the disk image, a word cloud module for providing a group of words that occur for a plurality of times in a particular file or document inside the disk image, a keyword search module allows the investigator to search for a presence of as particular word in a preferred document by keyword, and wherein the search results are displayed in a classified manner, where each classification is altered or changed based on a requirement of the investigator and an interactive link analysis module for presenting a content of the disk image in one or more graphical and intuitive manner.

According to an embodiment herein, the investigator provides a plurality of keywords to the disk analysis tool. The plurality of keywords is displayed graphically with a preset connection and information, and further the plurality of keywords is graphically linked to each other displaying a significance or relationship. The graphically displayed keywords define one or more relations with other similar entities for enhancing an insight or searching technique employed by the investigator.

According to an embodiment herein, the visualization and interactive analysis module provide the user to intelligently interrogate the data in the disk image with simple clicks and gestures and to concentrate on the investigation without missing any single aspect of preset information.

According to an embodiment herein, the visualization and interactive analysis module provides a pictorial and intuitive view of an ongoing investigation, and wherein the visualization and interactive analysis module comprises the advanced information visualization techniques to present the entire content of the exhibit for an investigator to interactively and intuitively explore the entire disk content.

According to an embodiment herein, the disk image content is represented through graphics and animation to enable a proper analysis of the exhibit data. The representation of the disk image content is displayed in a plurality of forms. The plurality of forms comprises a circular based group, a classification or type of each circle category, a sun burst partition schemas, radial tree schemas, and tilford tree schemas.

According to an embodiment herein, the circular based groups comprises an inner circle further comprising another group based on additional classifications, and the chain continues till the entire disk image is represented.

According to an embodiment herein, the tree based representations comprise a plurality of nodes indicated by a small spherical ball, and the plurality of nodes is connected by a plurality of branches. The node defines the main categories in the exhibit, and the branches between the plurality of nodes indicates a plurality of links and a plurality of connections between the plurality of nodes.

According to an embodiment herein, the text mining module analyzes a subject matter of each document and extracts a plurality of key features from each text based document.

According to an embodiment herein, the text mining module executes one or more algorithms for identifying and extracting the names of people, organizations, phone numbers, zip code, and addresses for future analysis.

According to an embodiment herein, the text mining module clusters the plurality of documents based on a similarity in the subject matter of the text based documents.

According to an embodiment herein, the text mining module clusters the plurality of documents based on a similarity in a type of application, and wherein the type of application includes word documents, Pdf files, PowerPoint presentations and slideshows.

According to an embodiment herein, the text mining module performs a keyword search for synonyms, homonyms and provides a part-of-speech suggestions to the investigator along with a result of word matching and retrieval operation.

According to an embodiment herein, the text mining module further comprises an entity extraction module for analyzing all the documents and providing a list of independent units with a specific meaning and wherein the independent units includes a name of a person, a company name, and an address, a text summarization module for examining each document in the disk image and presenting a summary of the each document to the investigator, a document clustering module sorts or classifies a group of documents based on a plurality of attributes and wherein the plurality of attributes includes a type of file, date created on, sender, creator, and date modified on and an email analysis module scrutinizes the exhibit's e-mail conversations and respective attachments, and reports a result of the e-mail analysis to the investigator.

According to an embodiment herein, the work flow and collaboration module comprises a case space module for allowing the investigator to control an allocation of a preset part of the disk to a team member based on a requirement and wherein the investigator is allowed to block an access to certain area of the disk image and restrict a team member to analyze only the allocated area a document review module for allowing the investigator to receive, allocate and review the documents based on the summarized text provided by the text summarization module of the text mining module and an email review for providing an assistance in reviewing relevant emails which are of utmost priority in a given case.

According to an embodiment herein, the workflow collaboration module allows an investigator to seamlessly collaborate and communicate with other investigating officers and engineers on a progress of the investigation.

According to an embodiment herein, the workflow collaboration module comprises a built in collaboration features for assisting the plurality of investigation teams.

According to an embodiment herein, the workflow collaboration module enables the investigating team to exchange a live analysis and share a ‘line-of-thinking’, share a complete or partial analysis with other team members or rest of team members in an investing group.

According to an embodiment herein, the workflow collaboration module provides a group posting of a plurality of messages and a plurality of collaborative features for improving an efficiency and effectiveness of an ongoing investigation.

According to an embodiment herein, the investigation management module provides a plurality of workflow and investigation management tools for a plurality of senior investigators, and wherein the investigating management module assists in keeping a track of an ongoing investigation leads for preparing a report for a case, and evidence handling.

According to an embodiment herein, the investigation management module comprises a case management module for enabling a skilled investigator to handle and manage a plurality of cases in parallel; an evidence management module for allowing the skilled investigator to manage one or more evidences found for a plurality of ongoing investigations and a report writing module for assisting the skilled investigator to prepare a report on the investigations in a short time and wherein the report writing module compiles all short notes and a plurality of comments provided by the plurality of investigators and team members in a preset document for future use, and wherein the skilled investigator rewrites the report in a preset format.

According to an embodiment herein, the evidence management module records and stores the evidences and the analysis of the evidences for a repeatability of the investigation and forensic analysis by another investigation team.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The other objects, features and advantages will occur to those skilled in the art from the following description of the preferred embodiment and the accompanying drawings in which:

FIG. 1 illustrates a block diagram of a system for a forensic analysis and investigation of a digital data/content stored in a disk image of a digital device by investigators, according to an embodiment herein.

FIG. 2 illustrates a block, diagram of the visualization and interactive analysis module, according to an embodiment herein.

FIG. 3 illustrates a block diagram of the text mining module, according to an embodiment herein.

FIG. 4 illustrates a block diagram of the workflow and collaboration module, according to an embodiment herein.

FIG. 5 illustrates a block diagram of the investigation management module, according to an embodiment herein.

FIG. 6 illustrates a flowchart explaining a method for analyzing and investigating digital data/content stored in a disk image of a digital device by investigators, according to an embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

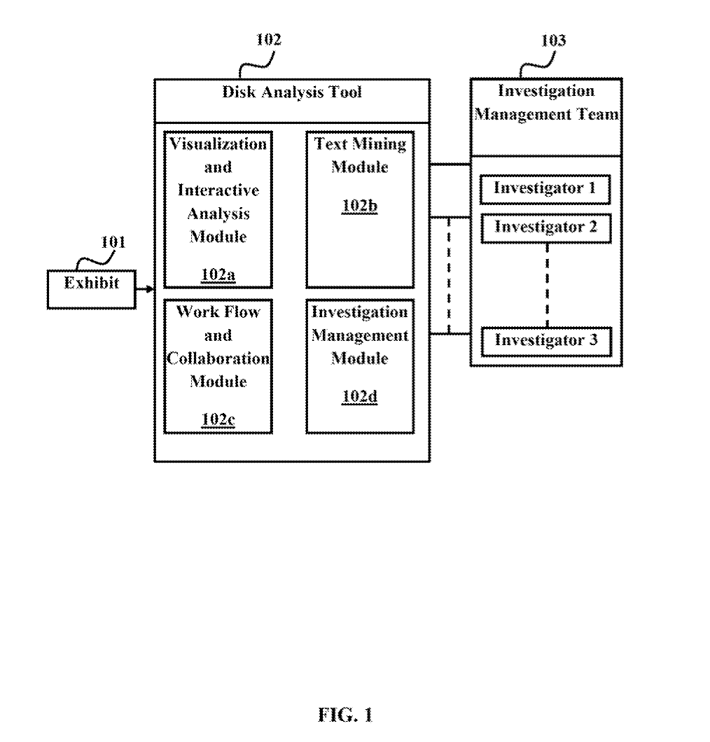

FIG. 1 illustrates a block diagram of a system for analyzing and digital ital data/content stored in a disk image of a digital device by investigating investigators, according to an embodiment herein. The system is a disk analysis tool 102 adopted for analyzing and investigating digital data/content stored in a disk image of a digital device by investigators. The disk analysis tool 102 comprises visualization and interactive analysis module 102a, text mining module 102b, workflow and collaboration module 102c, and investigation management module 103d. The disk analysis tool 102 acquires a disk image comprising digital data from a digital device of an exhibit 101. The visualization and interactive analysis module 102a of the disk analysis tool 102 analyzes the disk image through a graphical user interface or a browser interface for searching the evidence. The investigation management module 103d manages the investigation process with one or more investigation teams 103 comprising the plurality of investigators (103a, 103b . . . 103n). The workflow and collaboration module 102c handles the workflow collaboration within the investigation team members (103a, 103b . . . 103n). The text mining module 102b processes one or more text base documents, and the text mining module 102b further comprises one or more advanced text mining algorithms fir processing the text based documents to extract a critical information. The text miming algorithms are applied on the plurality of relevant documents and E-mail conversations to and from the exhibit 101. The entire disk image is represented visually to the investigation team 103 for easy, interactive and intuitive analysis of the exhibit 101.

According to an embodiment herein, the disk image is a copy of the hard disk of a user's exhibit's 101 in a digital multimedia device such as but not limited to a mobile phone, laptop, tablet, personal computer, etc.

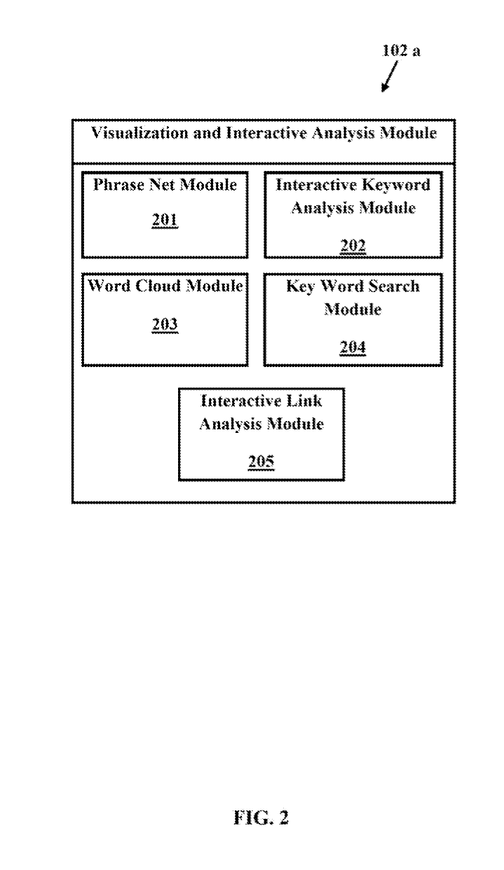

FIG. 2 illustrates a block diagram of the visualization and interactive analysis module, according to an embodiment herein. The visualization and interactive analysis module 102a further comprises a phrase net module 201, an interactive keyword analysis module 202, a word cloud module 203, a keyword search module 204 and an interactive link analysis module 205. The phrase net module 201 provides a resolution of a keyword used in multiple contexts. The phrase net module 201 further assists the investigator in differentiating the usage of keyword in multiple ways. The interactive keyword analysis module 202 provides a list of suitable keywords for searching in the disk image. The word cloud module 203 provides a group of words that occur more often in a particular file or document inside the disk image. The keyword search module 204 allows the investigator to search by the keyword for the presence of particular word in a preferred document, and further the keyword search module 204 displays the search results in classified manner, where each classification is altered or changed as per the requirement of the investigator. The interactive link analysis module 205 represents the content of the disk image in one or more graphical and intuitive manner.

According to an embodiment herein, the investigator himself/herself provides one or more keywords to the disk analysis tool. One or more keywords are displayed graphically with specific connection and information, and further one or more keywords are graphically linked to each other displaying the significance. The graphically displayed keywords define one or more relations with other similar entities which enhance the insight or searching technique employed by the investigator.

According to an embodiment herein, the visualization and interactive analysis module 102a provide the user to intelligently interrogate the data in the disk image with simple clicks and gestures and to concentrate more on the investigation without missing any single aspect of important information.

According to an embodiment herein, the visualization and interactive analysis module 102a provides a pictorial and intuitive view of an ongoing investigation. Further, the visualization and interactive analysis module 102b comprises one or more advanced information visualization techniques to present the entire content of the exhibit. for an investigator to interactively and intuitively explore the entire disk content.

According to an embodiment herein, the disk image content is represented through graphics and animations for enabling a proper analysis of the exhibit data. The representation of the disk image content is displayed in a plurality of forms such as but not limited to forming circular based groups and classifying each circle's category, forming sun burst partition schemas, radial tree schemas, and tilford tree schemas. The circular based groups comprise an inner circle further comprising another group based on additional classifications, and the chain continues till the entire disk image is represented. The tree based representations comprises plurality of nodes indicated by to small spherical ball, and connected by plurality of branches. The node defines the main categories in the exhibit, and the branches between pluralities of nodes describe various links and connection between the nodes.

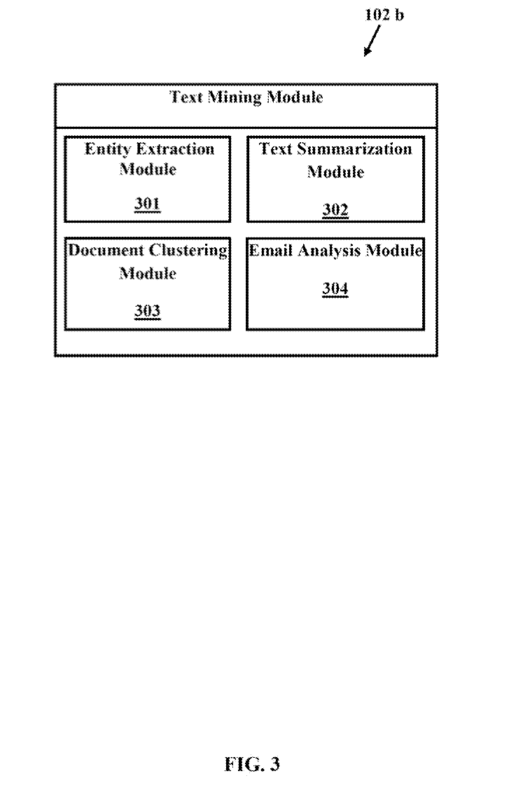

FIG. 3 illustrates a block diagram of the text mining module, according to an embodiment herein. The text mining module 102b analyzes the ‘subject’ of each document and extracts the key features from each of the text based documents. The text mining module 102b comprises an entity extraction module 301, a text summarization module 302, a document clustering module 303 and an email analysis module 304. The entity extraction module 301 analyzes all the documents and provides a list of independent units with a specific meaning such as but not limited to name of a person, company name, and address. The text summarization module 302 examines each document in the disk image and presents a summary of the respective document to the investigator. The document clustering module 303 sorts a group of documents based on specific attributes such as but not limited to a type of file, date created on, sender, creator, and date modified on. The email analysis module 304 scrutinizes the exhibit's e-mail conversations and respective attachments, and further reports the result to the specific investigator or to the investigating team.

According to an embodiment herein, the text mining module 102b executes one or more algorithms for identifying and extracting the specific attributes such as but not limited to names of people, organizations, phone numbers, zip code, and addresses for future analysis.

According to an embodiment herein, the text mining module 102b clusters the documents by similarity in terms of subject of the text based documents. The text mining module 102b clusters the documents by similarity in terms of type of application such as but not limited to word documents, Pdf files, PowerPoint presentations and slideshows.

According to an embodiment herein, the text mining module 102b performs a keyword searching process for synonyms, homonyms and provides part-of-speech suggestions to the specific investigator or to the investigating team along with word matching and retrieval. According to an embodiment herein, the text mining module comprises one or more advanced text mining algorithms for processing text based documents to extract critical information, and further the text miming algorithm are applied on the plurality of relevant documents and E-mails conversations to and from the exhibit.

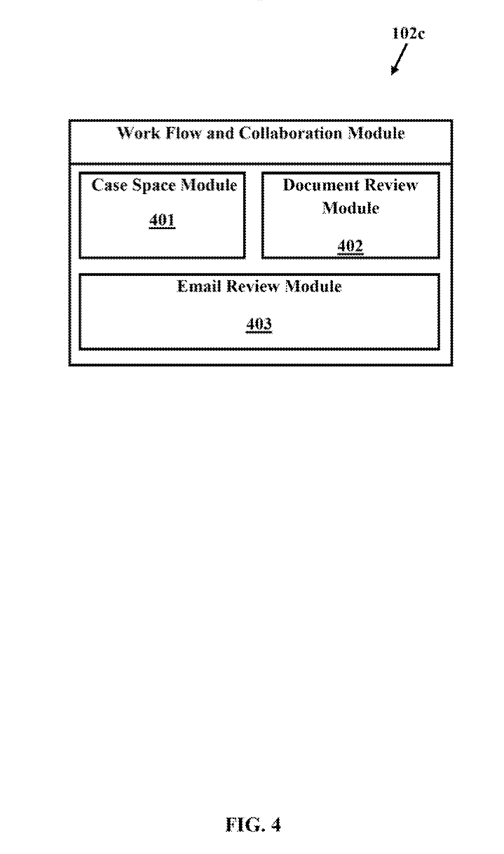

FIG. 4 illustrates a block diagram of the workflow and collaboration module, according to an embodiment herein. The workflow and collaboration module 102c comprises a case space module 401, a document review module 402 and an email review module 403. The case space module 401 allows the investigator to control the allocation of a particular part of the disk or disk image to a team member based on the requirement. The investigator is further allowed to block an access to certain area of the disk image and restrict the team member to analyze only the allocated area. The document review module 402 allows the investigator to receive, allocate and review the documents based on the summarized text provided by the text summarization module of the text mining module. The email review module 403 provides an assistance in reviewing relevant emails which are of upmost priority in the case.

According to an embodiment herein, the workflow collaboration module 102c further allows the investigator to seamlessly collaborate and communicate with other investigating officers and engineers within the investigating group on the progress of the investigation. Further, the workflow collaboration module 102c comprises a built in collaboration features for assisting the investigation teams. The workflow collaboration module 102c enables the investigating team to exchange live analysis and share a ‘line-of-thinking’, share complete or partial analysis with other team members the investigating team). The workflow collaboration module 102c enables group posting of messages and various other collaborative features for improving the efficiency and effectiveness of the ongoing investigation.

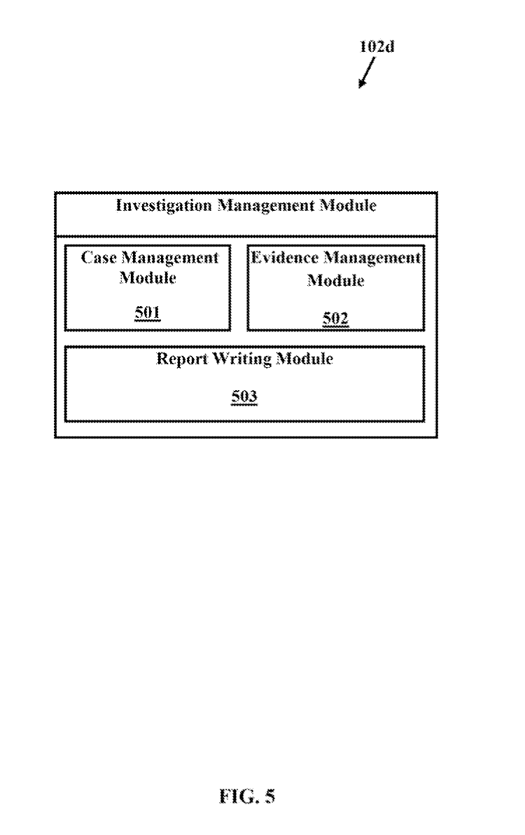

FIG. 5 illustrates a block diagram of the investigation management module, according to an embodiment herein. The investigation management module 102d provides the proper workflow and investigation management tools for the senior investigators. Further, the investigating management module 102d assists in keeping a track of the ongoing investigation leads, making a report for a case, and evidence handling. The investigation management module 102b comprises a case management module 501, an evidence management module 502, and a report writing module 503. The case management module 501 enables the superior investigators to handle and manage plurality of cases in parallel. The evidence management module 502 provides a tool for the superior investigators to manage one or more evidence found for plurality of ongoing investigations. The report writing module 530 assists the superior investigators to generate or create a report on the investigations in less time. The report writing module 503 compiles all the short notes, comments provided by the one or more investigators and team members in a specific document for future use, and the superior investigator revises the report based on a specific format. The evidence management module records and stores the evidences and the analysis of the evidences for a repeatability of the investigation and forensic analysis by another investigation team.

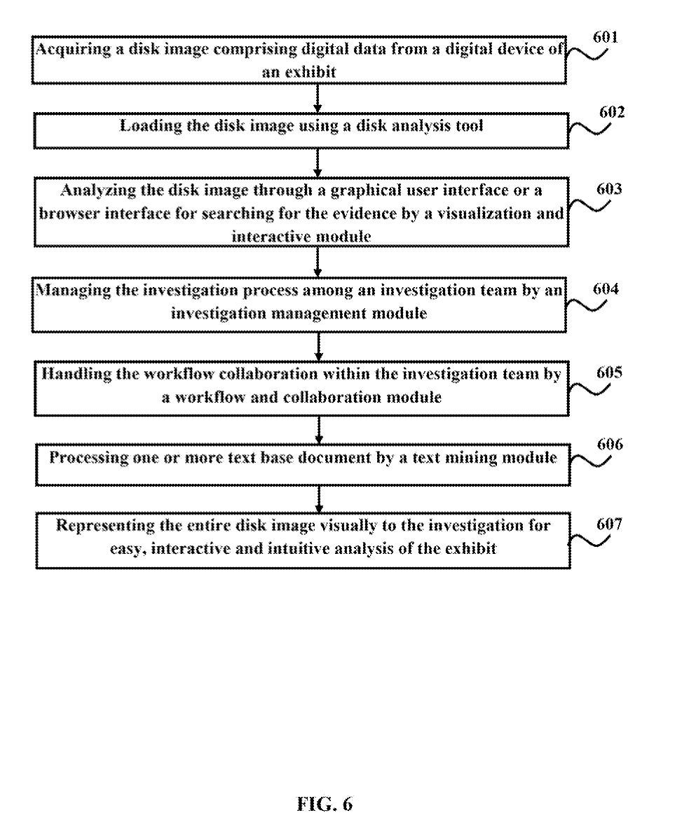

FIG. 6 is a flowchart illustrating a method for analyzing and investigating digital data/content stored in a disk image of a digital device by investigators, according to an embodiment herein. The method for analyzing and investigating digital data/content comprises the steps of acquiring a disk image comprising digital data from a digital device of an exhibit (Step 601); loading the disk image using a disk analysis tool (Step 602); analyzing, the disk image through a graphical user interface or a browser interface for searching for the evidence by a visualization and interactive analysis module (Step 603); managing the investigation process among an investigation team by an investigation management module (Step 604); handling the workflow collaboration within the investigation team by a workflow and collaboration module (Step 605); processing one or more text base documents by a text mining, module (Step 606); and representing the entire disk image visually to the investigator for easy, interactive and intuitive analysis of the exhibit (Step 607).

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A computer implemented method executed on a computing device for a forensic analysis and investigation of a digital data stored in a digital device, the method comprising steps of:
acquiring a disk image comprising digital data from a digital device of an exhibit;
loading the disk image using a disk analysis tool;
analyzing the disk image through a graphical user interface or a browser interface for searching for an evidence by a visualization and interactive analysis module;
managing an investigation process among an investigation team by an investigation management module;
handling a workflow collaboration within the investigation team by a workflow and collaboration module;
processing one or more text base documents by a text mining module, and wherein the text mining module comprises one or more advanced text mining algorithms for processing text based documents to extract a information, and wherein the text miming algorithm is applied on a plurality of ides ant documents and E-mails conversations to and from the exhibit; and
representing the entire disk image visually to the investigator for an interactive and intuitive analysis of the exhibit.

2. The method according to claim 1, wherein the disk image is a copy of a hard disk of a digital multimedia device of a user, and wherein the user is a suspect and a subject under investigation, and wherein the multimedia device includes mobile phone, laptop, tablet, and personal computer, and wherein the disk image is a forensic image of the device under investigation.

3. The method according to claim 1, wherein the visualization and interactive analysis module comprises:
a phrase net module for providing a resolution of a keyword used in a plurality of contexts, and wherein the phrase net module assists the investigator in differentiating a usage of keyword in a plurality of ways;
an interactive keyword analysis module for providing a list of suitable keywords for search in the disk image;
a word cloud module for providing a group of words that occur for a plurality of times in a particular file or document inside the disk image;
a keyword search module allows the investigator to search for a presence of particular word in a preferred document by keyword, and wherein the search results are displayed in a classified manner, where each classification is altered based on a requirement of the investigator; and
an interactive link analysis module for presenting a content of the disk image in one or more graphical and intuitive manner.

4. The method according to claim 1, wherein the investigator provides a plurality of keywords to the disk analysis tool, and wherein the plurality of keywords are displayed graphically with a preset connection and information, and wherein the plurality of keywords are graphically linked to each other displaying a significance or relationship, and wherein the graphically displayed keywords define one or more relations with other similar entities for enhancing an insight or searching technique employed by the investigator.

5. The method according to claim 1, wherein the visualization and interactive analysis module provide the user to intelligently interrogate the data in the disk image with simple clicks and gestures and to concentrate on the investigation without missing any single aspect of preset information.

6. The method according to claim 1, wherein the visualization and interactive analysis module provides a pictorial and intuitive view of an ongoing investigation, and wherein the visualization and interactive analysis module comprises advanced information visualization techniques to present the entire content of the exhibit for an investigator to interactively and intuitively explore the entire disk content.

7. The method according to claim 1, wherein the disk image content is represented through graphics and animation to enable a proper analysis of the exhibit data, and wherein the representation of the disk image content is displayed in a plurality of forms, wherein the plurality of forms includes a circular based groups, a classification or type of each circle category, a sun burst partition schemas, radial tree schemas, and tilford tree schemas.

8. The method according to claim 7, wherein the circular based groups comprises an inner circle further comprising another group based on additional classifications, and the chain continues till the entire disk image is represented.

9. The method according to claim 7, wherein the tree based representations comprise a plurality of nodes indicated by a small spherical ball, and wherein the plurality of nodes are connected by a plurality of branches, and wherein the node defines the main categories in the exhibit, and the branches between the plurality of nodes indicates a plurality of links and a plurality of connections between the plurality of nodes.

10. The method according to claim 1, wherein the text mining module analyzes a subject matter of each document and extracts a plurality of key features from each text based document.

11. The method according to claim 1, wherein the text mining module executes one or more algorithms for identifying and extracting names of people, organizations, phone numbers, zip code, and addresses for future analysis.

12. The method according to claim 1, wherein the text mining module clusters the plurality of documents based on a similarity in the subject matter of the text based documents.

13. The method according to claim 1, wherein the text mining module clusters the plurality of documents based on a similarity in a type of application, and wherein the type of application includes word documents, Pdf files, PowerPoint presentations and slideshows.

14. The method according to claim 1, wherein the text mining module performs a keyword search for synonyms, homonyms and provides part-of-speech suggestions to the investigator along with a result of word matching and retrieval operation.

15. The method according to claim 1, wherein the text mining module comprises:
an entity extraction module for analyzing all the documents and providing a list of independent units with a specific meaning and wherein the independent units includes a name of a person, a company name, and an address;
text summarization module for examining each document in the disk image and presenting a summary of the each document to the investigator;
a document clustering module sorts or classifies a group of documents based on a plurality of attributes and wherein the plurality of attributes includes a type of file, date created on, sender, creator, and date modified on; and
an email analysis module scrutinizes the exhibit's e-mail conversations and respective attachments, and reports a result of the e-mail analysis to the investigator.

16. The method according to claim 1, wherein the work flow and collaboration module comprises:
a case space module for allowing the investigator to control an allocation of a preset part of the disk to a team member based on a requirement and wherein the investigator is allowed to block an access to certain area of the disk image and restrict a team member to analyze only the allocated area;
a document review module for allowing the investigator to receive, allocate and review the documents based on the summarized text provided by the text summarization module of the text mining module; and
an email review for providing an assistance in reviewing relevant emails which are of utmost priority in a given case.

17. The method according to claim 1, wherein the workflow collaboration module allows an investigator to seamlessly collaborate and communicate with other investigating officers and engineers on a progress of the investigation.

18. The method according to claim 1, wherein the workflow collaboration module comprises a built in collaboration features for assisting the plurality of investigation teams.

19. The method according to claim 1, wherein the workflow collaboration module enables the investigating team to exchange a live analysis and share a ‘line-of-thinking’, share a complete or partial analysis with other team members or rest of team members in an investing group in real time to carry.

20. The method according to claim 1, wherein the workflow collaboration module provides a group posting of a plurality of messages and a plurality of collaborative features for improving an efficiency and effectiveness of an ongoing investigation.

21. The method according to claim 1, wherein the investigation management module provides a plurality of workflow and investigation management tools for a plurality of senior investigators, and wherein the investigating management module assists in keeping a track of an ongoing investigation leads for preparing a report for a case, and evidence handling.

22. The method according to claim 1, wherein the investigation management module comprises:
a case management module for enabling a skilled investigator to handle and manage a plurality of cases in parallel;
an evidence management module for allowing the skilled investigator to manage one or more evidences found for a plurality of ongoing investigations; and
a report writing module for assisting the skilled investigator to prepare a report on the investigations in a short time and wherein the report writing module compiles all short notes and a plurality of comments provided by the plurality of investigators and team members in a preset document for future use, and wherein the skilled investigator rewrites the report in a preset format.

23. The method according to claim 1, wherein the evidence management module records and stores the evidences and the analysis of the evidences for a repeatability of the investigation and forensic analysis by another investigation team.
